(19) United States
(12) Patent Application Publication
(10) Pub. No.: US 2016/0056463 A1
(43) Pub. Date: Feb. 25, 2016

(54) NON-AQUEOUS ELECTROLYTE SECONDARY BATTERY

(71) Applicant: SANYO ELECTRIC CO., LTD., Daito-shi, Osaka (JP)

(72) Inventors: Tomoki Tsuji, Osaka (JP); Takayuki Shirane, Osaka (JP); Shinji Mino, Osaka (JP); Shin Haraguchi, Osaka (JP)

(73) Assignee: SANYO Electric Co., Ltd., Daito-shi, Osaka (JP)

(21) Appl. No.: 14/779,031

(22) PCT Filed: Mar. 10, 2014
(86) PCT No.: PCT/JP2014/001344

§ 371 Date: Sep. 22, 2015

(30) Foreign Application Priority Data
Mar. 27, 2013 (JP) 2013-065934

(51) Int. Cl. H01M 4/525; H01M 10/0525; H01M 4/36; H01M 2/34

(52) U.S. Cl. CPC H01M 4/525; H01M 2/34; H01M 10/0525; H01M 4/364; H01M 2004/028

(57) ABSTRACT

A negative electrode-regulated non-aqueous electrolyte secondary battery comprises a negative electrode having a negative electrode active material layer, a positive electrode having a positive electrode active material layer, a separator interposed between the positive electrode and the negative electrode, and a non-aqueous electrolyte and stops charging as a result of the voltage drop of the negative electrode. In the non-aqueous electrolyte secondary battery, the size of the negative electrode active material layer is larger than the size of the positive electrode active material layer. The positive electrode active material layer contains a lithium-nickel composite oxide (A) represented by the general formula LiNiₓM₁₋ₓO₂ (where 0.7≦x<1 and M is one or more metals) and a lithium-nickel composite oxide (B) represented by the general formula LiNiₓCo_{y}M_{1-x-y}O₂ (where 0<x≦0.5, 0<y<1, and M is one or more metals except Co).

### TECHNICAL FIELD

The present invention relates to technology of a nonaqueous electrolyte secondary battery including a positive electrode that contains lithium-nickel composite oxides.

### BACKGROUND ART

Currently, a nonaqueous electrolyte secondary battery represented by a lithium ion secondary battery is widely used for consumer applications such as small portable devices because of its high energy density. In a general lithium ion secondary battery, a transition metal oxide such as LiCoO₂ has been used as a positive electrode active material, a carbon material such as graphite has been used as a negative electrode active material, and a nonaqueous electrolyte obtained by dissolving an electrolyte salt such as LiPF₆ in a nonaqueous solvent such as a carbonic acid ester has been used as an electrolyte solution.

Moreover, a nonaqueous electrolyte secondary battery using, as a negative electrode active material, lithium titanate that allows insertion/detachment reaction of the lithium ion to occur at an electric potential relative to that of lithium of about 1.5 V, the electric potential being nobler when lithium titanate is compared with carbon materials, has been proposed in recent years (see, for example, Patent Literatures 1 and 2).

Furthermore, a nonaqueous electrolyte secondary battery using, as a positive electrode active material, a lithium-nickel composite oxide represented by the general formula LiNiₓM₁₋ₓO₂ (where 0.7≦x<1, and M represents one or more metals) has been proposed (see, for example, Patent Literature 2).

### CITATION LIST

### Patent Literature

Patent Literature 1

Japanese Patent Laid-Open Publication No. 2010-153258

Patent Literature 2

Japanese Patent Laid-Open Publication No. 2007-80738

### SUMMARY OF INVENTION

### Technical Problem

Now, various proposals have been made on a high-capacity nonaqueous electrolyte secondary battery, however a nonaqueous electrolyte secondary battery having a further higher capacity has been demanded in applying the nonaqueous electrolyte secondary battery to a power source for electric power storage facilities and to a power source for vehicles such as an HEV.

Moreover, regarding the lithium-nickel composite an irreversible change in the crystal structure is liable to occur during charge and discharge, and therefore there is a problem that cyclability is greatly lowered.

Thus, it is an object of the present invention to provide a nonaqueous electrolyte secondary battery that may achieve a high capacity and may suppress lowering of the cyclability.

### Solution to Problem

The nonaqueous electrolyte secondary battery of an embodiment of the present invention includes a negative electrode having a negative electrode active material layer; a positive electrode having a positive electrode active material layer; a separator interposed between the positive electrode and the negative electrode; and a nonaqueous electrolyte, the battery being a negative electrode restricted nonaqueous electrolyte secondary battery that stops charging as a result of an electric potential drop of the negative electrode, wherein the size of the negative electrode active material layer is larger than the size of the positive electrode active material layer, and the positive electrode active material layer contains: a lithium-nickel composite oxide A represented by the general formula LiNiₓM₁₋ₓO₂ (where 0.7≦x<1, and M represents one or more metals); and a lithium-nickel composite oxide B represented by the general formula LiNiₓCo_{y}M_{1-x-y}O₂ (where 0<x≦0.5, 0<y<1, and M represents one or more metals excluding Co).

### Advantageous Effects of Invention

According to the present invention, a nonaqueous electrolyte secondary battery that achieves a high capacity and suppresses lowering of the cyclability may be provided.

### BRIEF DESCRIPTION OF DRAWINGS

FIG. 1 is a schematic sectional view illustrating an example of the constitution of a nonaqueous electrolyte secondary battery according to the present embodiment.

FIG. 2 is a schematic view illustrating an opposing state of a negative electrode active material layer and a positive electrode active material layer.

FIG. 3 is a view showing charge and discharge curves of a positive electrode and a negative electrode of a nonaqueous electrolyte secondary battery.

FIG. 4 shows the cyclability of nonaqueous electrolyte secondary batteries in the case where a ratio of an area of a negative electrode active material layer to an area of a positive electrode active material layer (area of negative electrode active material layer/area of positive electrode active material layer) is equal to 1, 1.1, and 1.3.

FIG. 5 is a view showing polarization performances of a positive electrode containing a lithium-nickel composite oxide A and a positive electrode containing a lithium-nickel composite oxide B.

FIG. 6 is a view showing results of the cyclability of test cells 1 to 2.

### DESCRIPTION OF EMBODIMENT

Hereinafter, an embodiment of the present invention will be explained. The present embodiment is an example of practicing the present invention, and the present invention is not limited to the present embodiment.

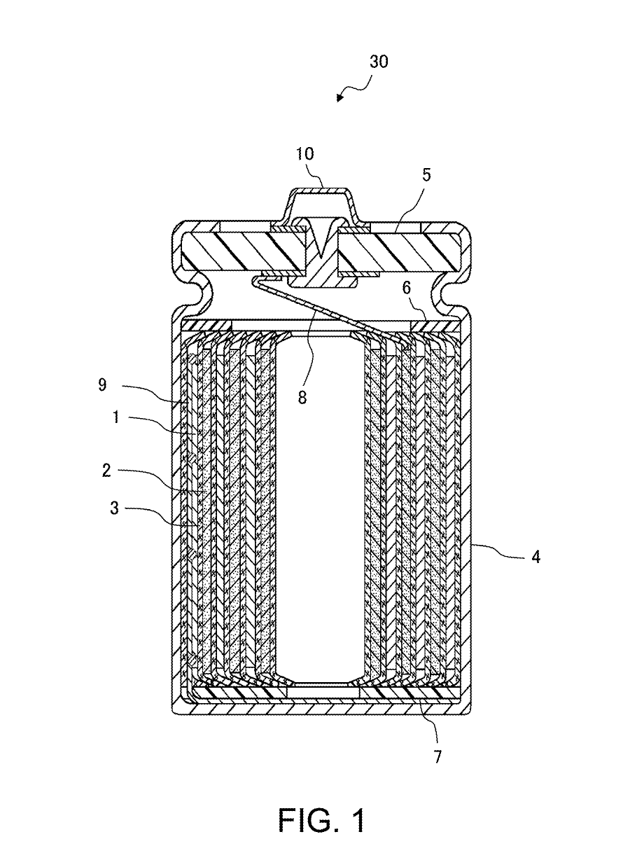

FIG. 1 is a schematic sectional view illustrating an example of the constitution of a nonaqueous electrolyte secondary battery according to the present embodiment. The nonaqueous electrolyte secondary battery 30 illustrated in FIG. 1 includes a negative electrode 1, a positive electrode 2, a separator 3 interposed between the negative electrode 1 and the positive electrode 2, a nonaqueous electrolyte (electrolyte solution), a cylindrical battery case 4, and a sealing plate 5. The nonaqueous electrolyte is injected into the battery case 4. The negative electrode 1 and the positive electrode 2 are wound with the separator 3 interposed therebetween, and constitute a wound type electrode group together with the separator 3. An upper insulating plate 6 and a lower insulating plate 7 are installed at both ends in a longitudinal direction of the wound type electrode group, and housed in the battery case 4. One end of a positive electrode lead 8 is connected to the positive electrode 2, and the other end of the positive electrode lead 8 is connected to a positive electrode terminal 10 that is provided with the sealing plate 5. One end of a negative electrode lead 9 is connected to the negative electrode 1, and the other end of the negative electrode lead 9 is connected to the internal bottom of the battery case 4. The connection between leads and members is conducted by welding or the like. An open end of the battery case 4 is crimped onto a sealing plate 5 to seal the battery case 4.

The negative electrode 1 includes is negative electrode collector and a negative electrode active material layer provided on the negative electrode collector. The negative electrode active material layer is preferably arranged on both faces of the negative electrode collector, but may be provided on one face of the negative electrode collector. The negative electrode active material layer contains a negative electrode active material, and may also contain a negative electrode additive or the like added therein in addition to the negative electrode active material.

The negative electrode active material includes publicly known negative electrode active materials used for nonaqueous electrolyte secondary batteries such as a lithium ion battery, and examples thereof include carbon-based active materials, silicon-based active materials containing silicon and lithium titanate. Examples of the carbon-based compound include artificial graphite, natural graphite, hardly graphitizable carbon and easily graphitizable carbon. Examples of the silicon-based active material include silicon, silicon compounds, and partially substituted compounds or solid solutions thereof. The silicon compound is preferably, for example, silicon oxides represented by SiOₐ (where 0.05<a<1.95).

The negative electrode active material here is particularly preferably lithium titanate from the viewpoint of having a small volume expansion during charge and discharge, exhibiting a favorable cyclability, and so on, more preferably lithium titanate represented by the chemical formula Li₄₊ₓTi₅O₁₂ (0≦x≦3), and an example thereof includes Li₄Ti₅O₁₂. In addition, lithium titanate in which a part of Ti is substituted with another element such as, for example, Al or Mg may be used.

The negative electrode additive is, for example, a binder and a conductive agent. Examples of the conductive agent include acetylene black, carbon black and graphite. Moreover, examples of the binder include polytetrafluoroethylene (PTFE), polyvinylidene fluoride (PVdF) and fluorine-based rubber.

The negative electrode collector is constituted by, for example, a publicly known conductive material used for nonaqueous electrolyte secondary batteries such as a lithium ion battery, and examples of the negative electrode collector include nonporous conductive substrates. The thickness of the negative electrode collector is preferably in the range of, for example, about 1 μm or more and about 500 μm or less.

The positive electrode 2 includes a positive electrode collector and a positive electrode active material layer. The positive electrode active material layer is preferably arranged on both faces of the positive electrode collector, but may be arranged only on one face side of the positive electrode collector. The positive electrode active material layer contains a positive electrode active material, and may also contain a positive electrode additive added therein in addition to the positive electrode active material.

The positive electrode active material contains a lithium-nickel composite oxide A represented by the general formula LiNiₓM₁₋ₓO₂ (where 0.7≦x<1, and M represents one or metals) and a lithium-nickel composite oxide B represented by the general formula LiNiₓCo_{y}M_{1-x-y}O₂ (where 0<x≦0.5, 0<y<1, and M represents one or more metals excluding Co). The lithium-nickel composite oxide B is a positive electrode active material in which it is harder for an irreversible change in the crystal structure during Charge and discharge to occur than in the lithium-nickel composite oxide A. It is considered that the reason for this is because the composition ratio of Ni in the composite oxide is smaller in the lithium-nickel composite oxide B.

The positive electrode additive is, for example, a binder or a conductive agent. As the binder and the conductive agent, the same substances used for the negative electrode 1 may be used.

The positive electrode collector is constituted by, for example, a publicly known conductive material used for nonaqueous electrolyte secondary batteries such as a lithium ion secondary battery, and examples thereof include nonporous conductive substrates.

Hereinafter, explanation will be given on how to achieve a high capacity and suppress lowering of the cyclability for the nonaqueous electrolyte secondary battery in the present embodiment.

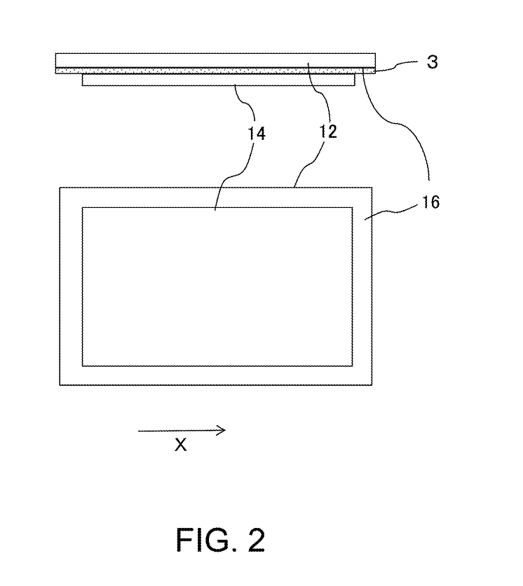

FIG. 2 is a schematic view illustrating an opposing state of the negative electrode active material layer and the positive electrode active material layer, and shows: a state (lower view) in which the opposing state of the negative electrode active material layer 12 and the positive electrode active material layer 14 is viewed from the reverse side of the positive electrode active material layer 14 in a state before manufacturing the aforementioned wound type electrode group, namely in a state in which the negative electrode and positive electrode are laminated with the separator interposed therebetween; and a view (upper view) in which the lamination state is viewed from above (the separator 3 is omitted in the lower view). In addition, in the case where the wound type electrode group is manufactured, the negative electrode containing a negative electrode active material layer 12 and the positive electrode containing the positive electrode active material layer 14 are wound in the longitudinal direction (in the direction of arrow mark X shown in FIG. 2) of the negative electrode active material layer 12 and the positive electrode active material layer 14 shown in FIG. 2.

In the present embodiment, the size of the negative electrode active material layer 12 is designed to be larger than the size of the positive electrode active material layer 14. That is to say, as shown in FIG. 2, the opposing positive electrode active material layer 14 does not exist at an end portion of the outer circumference of the negative electrode active material layer 12, and a state in which the negative electrode active material layer 12 protrudes from the end portion of the outer circumference of the positive electrode active material layer 14 is made. In such a state, when the negative electrode containing the negative electrode active material layer 12 and the positive electrode containing the positive electrode active Material layer 14 are wound, the end portion of the outer circumference of the negative electrode active material layer 12 which protrudes from the positive electrode active material layer 14 becomes an unopposed region 16 where the opposing positive electrode active material layer 14 does not exist. Usually, the opposing positive electrode active material layer 14 does not exist in the unopposed region 16 of the negative electrode active material layer 12, and therefore the unopposed region 16 of the negative electrode active material layer 12 hardly contributes to charge and discharge reaction, but by carrying out negative electrode restriction that stops charging of the nonaqueous electrolyte secondary battery due to an electric potential drop of the negative electrode, the charge and discharge reaction may be made to progress between the unopposed region 16 of the negative electrode active material layer 12 and the positive electrode active material layer 14 at the end portion of the outer circumference near the unopposed region 16 resulting in the rise in the utilization coefficient of the negative electrode active material layer, and therefore the nonelectrolyte secondary battery may be made so as to achieve a high capacity. Hereinafter, the negative electrode restriction will be explained.

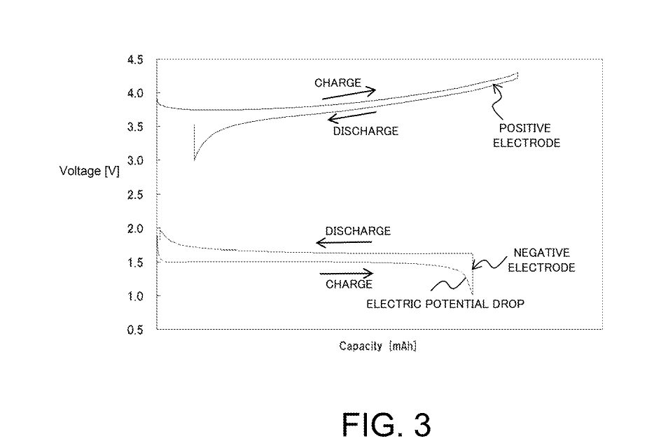

FIG. 3 is a view showing charge and discharge curves of the positive electrode and the negative electrode of the nonaqueous electrolyte secondary battery. Here, lithium titanate is used as a negative electrode active material, and the lithium-nickel composite Oxide A represented by LiNiₓM₁₋ₓO₂ (where 0.7≦x<1, and M represents one or more metals) is used as a positive electrode active Material. As shown in FIG. 3, the electric potential of the positive electrode containing the lithium-nickel composite oxide A gradually rises during the charging of the nonaqueous electrolyte secondary battery, while the electric potential of the negative electrode containing lithium titanate is maintained at around 1.5V (flat region), and the electric potential of the negative electrode drops at the end of charging. The electric potential of the negative electrode containing lithium titanate in particular drops rapidly at the end of charging, and it is considered that a reaction occurs between the unopposed region of the negative electrode active material layer and the positive electrode active material layer at the end portion of the outer circumference at around the time when the electric potential of the negative electrode drops. Furthermore, when the charge and discharge cycle, in which discharge is conducted after charging is stopped by such an electric potential drop of the negative electrode, is repeated, the utilization coefficient of the unopposed region of the negative electrode active material layer rises. As a result thereof, when the charge and discharge cycle is repeated, the charging and discharging capacities gradually increase, and therefore a high capacity may be achieved. As a specific example of the negative electrode restriction, the negative electrode restriction is desirably conducted by a control system including: a stop-of-charge control apparatus that Stops charging of the nonaqueous electrolyte secondary battery; and an electric potential sensor for the negative electrode which detects the electric potential of the negative electrode. For example, when the electric potential value of the negative electrode detected by the electric potential sensor for the negative electrode is compared with a preset reference value by the stop-of-charge control apparatus during the charging of the nonaqueous electrolyte secondary battery, the charging of the nonaqueous electrolyte secondary battery is stopped in the case where the detected electric potential of the negative electrode is lower than the reference value.

In addition, in the case of carrying out positive electrode restriction that stops charging of the nonaqueous electrolyte secondary battery in the flat region of the electric potential of the negative electrode, namely by an electric potential change of the positive electrode, the electric potential at which the reaction occurs between the unopposed region of the negative electrode active material layer and the positive electrode active material layer at the end portion of the outer circumference may not be detected from the electric potential of the positive electrode, and therefore it is difficult to raise the utilization coefficient of the unopposed region of the negative electrode active material layer to thereby achieve a high capacity.

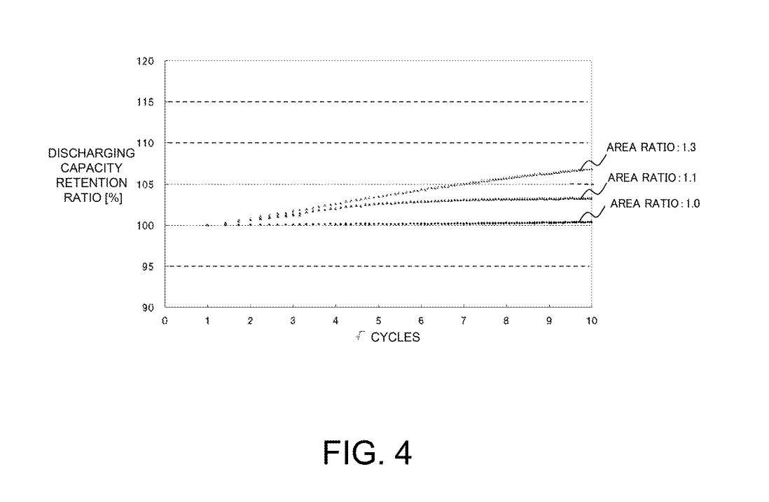

FIG. 4 shows the cyclability of the nonaqueous electrolyte secondary batteries in the case where a ratio of the area of the negative electrode active material layer to the area of the positive electrode active material layer (area of negative electrode active material layer/area of positive electrode active material layer) is equal to 1, 1.1, and 1.3. Here, lithium titanate is used as a negative electrode active material, and a lithium-nickel composite oxide A represented by LiNiₓM₁₋ₓO₂ (where 0.7≦x<1, and M represents one or more metals) is used as a positive electrode active material, and the negative electrode restriction, that stops charging of the nonaqueous electrolyte secondary battery as a result of an electric potential drop of the negative electrode, is carried out. In addition, the discharging capacity retention ratio on the vertical axis in FIG. 4 represents a ratio (a value determined as percentages) of the discharging capacity in each cycle after the first cycle to the discharging capacity in the first cycle.

As shown in FIG. 4, in the case where the area of the negative electrode active material layer/the area of the positive electrode active material layer is equal to 1, namely in the case where the unopposed region is not formed, the discharging capacity retention ratio hardly changes until 100 cycles. However, in the case where the area of the negative electrode active material layer/the area of the positive electrode active material layer is equal to 1.1, the discharging capacity retention ratio increases until about 50 cycles, and in the Case where, the area of the negative electrode active material layer/the area of the positive electrode active material layer is equal to 1.3, the discharging capacity retention ratio increases over the range of 1 cycle to 100 cycles. In this way, by making the area of the negative electrode active material layer larger than the area of the positive electrode active material layer and carrying out the negative electrode restriction that stops charging of the nonaqueous electrolyte secondary battery as a result of an electric potential drop, the nonaqueous electrolyte secondary battery may be made so as to achieve a high capacity. The area of the negative electrode active material layer/the area of the positive electrode active material layer is preferably set to be larger than 1.0 from the viewpoint of achieving a high capacity, and is more preferably set to be in the range of 1.1 to 1.3 from the viewpoint of making small-sized and high-capacity batteries. Moreover, in the case where lithium titanate is used as a negative electrode active material, the occurrence of lithium dendrite formed on the negative electrode may be suppressed by making the size of the negative electrode active material layer larger than the size of the positive electrode active material layer.

In this way, by making the size of the negative electrode active material layer larger than the size of the positive electrode active material layer, and carrying out the negative electrode restriction that stops charging of the nonaqueous electrolyte secondary battery as a result of an electric potential drop of the negative electrode, the utilization coefficient of the unopposed region of the negative electrode active material layer rises high capacity may be achieved. However, when the utilization coefficient of the unopposed region of the negative electrode active material layer rises, excessive lithium is inserted and detached from the positive electrode active material. Therefore, in the positive electrode active material consisting of the lithium-nickel composite oxide A represented by LiNiₓM₁₋ₓO₂ (where 0.7≦x<1, and M represents one or more metals), the irreversible change in the crystal structure is brought about during charge and discharge to lower the cyclability of the nonaqueous electrolyte secondary battery.

However, the positive electrode active material of the present embodiment contains the lithium-nickel composite oxide B represented by the general formula LiNiₓCo_{y}M_{1-x-y}O₂ (where 0<x≦0.5, 0<y<1 and M represents one or more metals excluding Co) in addition to the lithium-nickel composite oxide A represented by the general formula LiNiₓM₁₋ₓO₂ (where 0.7≦x<1 and M represents one or more metals) and therefore may suppress lowering of the cyclability of the nonaqueous electrolyte secondary battery by suppressing the irreversible change in the crystal structure of the lithium-nickel composite oxide A or the like.

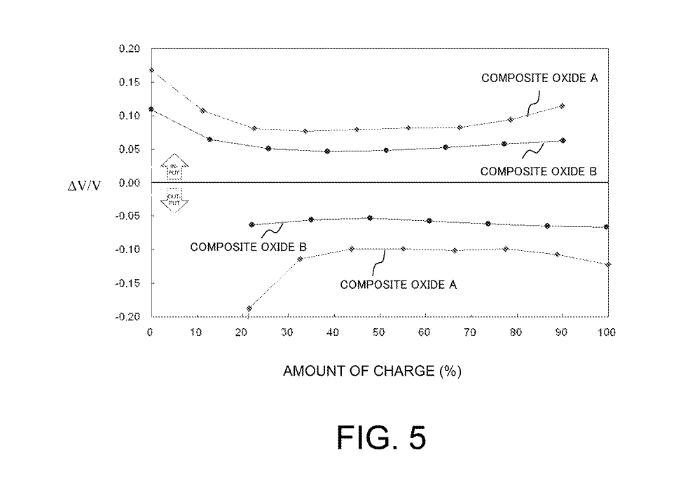

FIG. 5 is a view showing the polarization performances of the positive electrode containing the lithium-nickel composite oxide A and the positive electrode containing the lithium-nickel composite oxide B. The vertical axis in FIG. 5 represents the polarization value, and it may be said that as the value is smaller, the resistance smaller and it is easier to perform the insertion and detachment of lithium. Moreover, the horizontal axis in FIG. 5 represents the amount of charge of the battery. As shown in FIG. 5, the polarization of the positive electrode containing the lithium-nickel composite oxide B represented by the general formula LiNiₓCo_{y}M_{1-x-y}O₂ (where 0<x≦0.5, 0<y<1 and M represents one or more metals excluding Co) becomes smaller than the polarization of the positive electrode containing the lithium-nickel composite oxide A represented by the general formula LiNiₓM₁₋ₓO₂ (where 0.7≦x<1 and M represents one or more metals) on both the output side and the input side. The difference in polarization between the positive electrodes becomes larger particularly when the amount of charge of the battery is higher or lower. That is to say, it becomes easier to perform insertion and detachment of lithium from the lithium-nickel composite oxide B having a lower polarization than from the lithium composite oxide A, as the charging of the battery proceeds to make the amount of charge higher or the discharging of the battery proceeds to make the amount of charge lower. Accordingly, when the reaction occurs between the unopposed area of the negative electrode active material layer and the positive electrode active material layer at the end of charge and discharge, or the like, the insertion and detachment of lithium are performed more from the lithium-nickel composite oxide B than from the lithium-nickel composite oxide A, and therefore excessive insertion and detachment of lithium from the lithium-nickel composite oxide A are inhibited to suppress the irreversible change in the crystal structure of the lithium-nickel composite oxide A. Moreover, as mentioned previously, it is harder for the irreversible change in the crystal structure during charge and discharge to occur in the lithium-nickel composite oxide B than in the lithium-nickel composite oxide A. As a result thereof, lowering of the cyclability of the nonaqueous electrolyte secondary battery may be suppressed.

Hereinafter, preferable conditions and other constituent elements of the nonaqueous electrolyte secondary battery of the present embodiment will be explained.

The metal M in the lithium-nickel composite oxide A represented by the general formula LiNiₓM₁₋ₓO₂ is preferably at least one metal selected from Co, Al, Mn, and Ti from the viewpoint of achieving a high capacity, more preferably Co or Al, and examples include LiNi_{0.82}Co_{0.15}Al_{0.03}.

The metal M in the lithium-nickel composite oxide B represented by the general formula LiNiₓCo_{y}M_{1-x-y}O₂ (where 0<x≦0.5, 0<y<1 and M represents one or more metals excluding Co) is preferably at least one metal selected from Mn, Al, and Ti from the viewpoint Of suppressing lowering of the cyclability and improving the polarization performance, and examples include LiNi_{0.5}Co_{0.3}Mn_{0.2}.

The mass ratio of the lithium-nickel composite oxide B to the lithium-nickel composite oxide. A is preferably in the range of 0.1 or more and less than 0.5. In the case where the mass ratio of the lithium-nickel composite oxide B to the lithium-nickel composite oxide A is less than 0.1, it sometimes occurs that lowering of the cyclability may not be suppressed, and in the case where the mass ratio is 0.5 or more, the ratio of the lithium-nickel composite oxide A is lowered, and therefore it sometimes occurs that the battery capacity is lowered.

The method for producing the lithium-nickel composite oxides A and B is not particularly limited, and the lithium-nickel composite oxides A and B are obtained by mixing a lithium oxide as a Li source and oxides of Ni and other metals, and firing the resultant mixture under an air atmosphere. The composition ratio of each metal in the lithium-nickel composite oxides A and B is adjusted by the molar ratio of each oxide in the mixture, or the like.

The nonaqueous electrolyte contains a nonaqueous solvent and an electrolyte salt. As the nonaqueous solvent, for example, ethylene carbonate (EC), propylene carbonate (PC), dimethyl carbonate (DMC), diethyl carbonate (DEC) and ethyl methyl carbonate (EMC) may be used. These are preferably used in combination of plural kinds.

The nonaqueous solvent of present embodiment is not limited to contain other solvents as specifically described above and may contain, for example, cyclic ethers such as tetrahydrofuran (THF) and 2-methyl tetrahydrofuran (2MeTHF); chain ethers such as dimethoxyethane (DME); γ-butyrolactone (GBL), acetonitrile (AN), sulfolane (SL), and various ionic liquids, or various normal-temperature molten salts.

The electrolyte salt used in the present embodiment is not particularly limited, and the electrolyte salts such as, for example, LiClO₄, LiBF₄, LiAsF₆, LiPF₆, LIPF(CF₃)₅, LiPF₂(CF₃)₄, LiPF₃(CF₃)₃, LiPF₄(CF₃)₂, LiPF₅(CF₃), LiPF₃(C₂F₅)₃, LiCF₃SO₃, LiN(CF₃SO₂)₂, LiN(C₂F₅SO₂)₂, LIN(C₂F₅CO)₂, LiI, LiAlCl₄, and LiBC₄O₈ may be used alone or in combination of two or more.

Among others, LiPF₆ is preferably used because the ion conductivity is favorable. The concentration of these electrolyte salts is preferably set to 0.5 to 2.0 mol/dm³. Furthermore, the concentration of the electrolyte salts is more preferably set to 1.5 to 2.0 mol/dm³. Moreover, the electrolyte salt may also be used when at least one selected from the group consisting of: carbonates such as vinylene carbonate and butylene carbonate; benzenes such as biphenyl and cyclohexylbenzene; sulfur compounds such as propanesultone; and ethylene sulfide, hydrogen fluoride, triazole-based cyclic compounds, fluorine-containing esters, a hydrogen fluoride complex of tetraethylammonium fluoride and derivatives thereof, phosphazene and derivatives thereof, amide group-containing compounds, imino group-containing compounds, and nitrogen-containing compounds, is contained in the electrolyte salt. Moreover, the electrolyte salt may also be used when at least one selected from CO₂, NO₂, CO, SO₂, and the like is contained therein.

As the separator 3, for example, a sheet or the like made of a resin having a predetermined ion permeability, mechanical strength, insulation properties, and so on may be used. The thickness of the separator 3 is preferably in the range of, for example, about 10 μm or more and about 300 μm or less. Moreover, the porosity of the separator 3 is preferably in the range of about 30% or more and about 70% or less. In addition, the porosity is expressed as percentages of the total volume of pores that are contained in the separator 3 relative to the volume of the separator 3.

In addition, the nonaqueous electrolyte secondary battery 30 in FIG. 1 is a cylindrical battery including a wound type electrode group, but the shape of the battery is not particularly limited, and the battery may be, for example, a square battery, a flat battery, a coin battery, or a laminated film pack battery.

### EXAMPLES

Hereinafter, the present invention will be further explained by an example, but the present invention is not limited to the Example.

### Example

### Manufacture of Positive Electrode

Ni_{0.80}Co_{0.15}Al_{0.05}O₂, was used as a lithium-nickel composite oxide A, LiNi_{0.35}Co_{0.35}Mn_{0.30}O₂ was used as a lithium-nickel composite oxide B, and a positive electrode active material consisting of the lithium-nickel composite oxides A and B in a mass ratio of A to B of 8:2, a carbon powder as a conductive agent, and polyvinylidene fluoride (PVdF) as a binder were mixed so that the mass ratio of the positive electrode active material, the conductive agent, and the binder was 100:5:2.55, then the resultant mixture was kneaded, and thereafter N-methyl-2-pyrrolidone as a dispersion medium was added therein to prepare a positive electrode slurry. The positive electrode slurry was applied on both faces of an aluminum foil (thickness 15 μm) as a positive electrode collector and dried to manufacture positive: electrode active material layers on the aluminum foil, and thereafter the positive electrode active material layers on the aluminum foil were rolled with a rolling roller to manufacture a positive electrode. Moreover, a positive electrode lead was attached to the obtained positive electrode.

### [Manufacture of Negative Electrode]

Li₄Ti₅O₁₂ as a negative electrode active material, a Carbon powder as a conductive agent, and polyvinylidene fluoride (PVdF) as a binder were mixed so that the mass ratio of the negative electrode active material, the conductive agent, and the binder was 100:7:3, then the resultant mixture was kneaded, and thereafter N-methyl-2-pyrrolidone as a dispersion medium was added thereto to prepare a negative electrode slurry. The negative electrode slurry was applied on both faces of an aluminum foil (thickness 15 μm) as a negative electrode collector and dried to manufacture negative electrode active material layers on the aluminum foil, and thereafter the negative electrode active material layers on the aluminum foil were rolled with a rolling roller to manufacture a negative electrode. Moreover, a negative electrode lead was attached to the obtained negative electrode.

### [Ratio of Area of Negative Electrode Active Material Layer to Area of Positive Electrode Active Material Layer]

The ratio of the area of the negative electrode active material layer to the area of the positive electrode active material layer (area of negative electrode active material layer/area of positive electrode active material layer) was 1.27.

### [Preparation of Nonaqueous Electrolyte]

Lithium hexaflucrophosphate (LiPF₆) was dissolved in a mixed solvent obtained by mixing propylene carbonate (PC), diethyl carbonate (DEC), and dimethyl carbonate (DMC) in a volume ratio of 25:70:5, so that the concentration was 1.2 mol/L to prepare a nonaqueous electrolyte (electrolyte solution), and then LiPO₂F₂ was dissolved therein as an additive in a concentration of 0.9 wt % relative to the total weight of the electrolyte solution.

### [Test Cell]

The positive electrode and negative electrode manufactured as described above were laminated with a separator interposed therebetween, and the obtained laminated product was wound to manufacture an electrode group. The electrode group was housed in an aluminum laminate film as an exterior body, the aforementioned nonaqueous electrolyte was injected into the aluminum laminate film, and thereafter the aluminum laminate film was tightly sealed to manufacture a test cell 1.

### [Evaluation of Cyclability of Test Cell l]

The test cell 1 was housed in a thermostatic chamber at 20° C., charged by a constant current/constant voltage system as described below, and discharged by a constant current system. However, the end of charging was determined by negative electrode restriction. The test cell 1 was charged at a constant current of 1C rate (1C is defined as a value of current at which the whole battery capacity can be consumed in 1 hour) until the voltage at the negative elect rode became 1.4 V or lower and the battery voltage became 2.8 V. After the battery voltage reached 2.8 V, the test cell was charged at a constant voltage of 2.8 V until the current value reached 0.05C. Next, the charge was suspended for 20 minutes, and thereafter the test cell after charging was discharged at a constant current of 1C rate until the battery voltage became 1.5 V. Such charge and discharge were repeated for 1000 cycles. A ratio (a value determined as percentages) of the discharging capacity of each cycle after the first cycle to the discharging capacity at the first cycle was calculated and determined as a discharging capacity retention ratio. It may be said that the cyclability is lowered more as the discharging capacity retention ratio is lowered.

### Comparative Example

A test cell 2 was manufactured in the same Manner as in Example except that only LiNi_{0.80}Co_{0.15}Al_{0.05}O₂ was used as a positive electrode active material. Moreover, the cyclability of the test cell 2 was also evaluated under the same conditions as in the evaluation of the test cell 1.

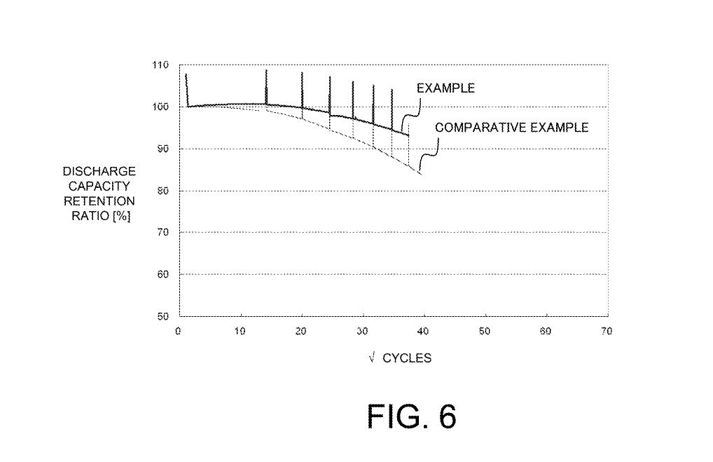

FIG. 6 is a view showing the results of the cyclability of test cells 1 and 2.

As shown in FIG. 6, in the test cells 1 and 2, the discharging capacity retention ratio was increased during the cycles from 1 to 100 by making the size of the negative electrode active material layer larger than the size of the positive electrode active material layer and carrying but negative electrode restriction to stop charging. That is to say, it may be said that by making the size of the negative electrode active material layer larger than the size of the electrode active material layer and carrying out the negative electrode restriction to stop charging, a high capacity was able to be achieved. Particularly, the rise in the discharging capacity retention ratio of the test cell 1 using the positive electrode active material consisting of the lithium-nickel composite oxides A and B was larger than that of the test cell 2 using the positive electrode active material consisting of the lithium-nickel composite oxide A. It is considered as a factor that the increase and lowering of the discharging capacity retention ratio simultaneously progress during the cycles from 1 to 100 and lowering of the discharging capacity retention ratio is smaller in the test cell 1 than in the test cell 2. Furthermore, in the test cell 1 using the positive electrode active material consisting of the lithium-nickel composite oxides A and B, the discharging capacity retention ratio at 100 cycles was lowered by only about 5%, while on the other hand, the discharging capacity retention ratio was lowered by as much as about 15% in the test cell 2 using the positive electrode active material consisting of the lithium-nickel composite oxide A. That is to say, by using the positive electrode active material containing the lithium-nickel composite oxide A represented by the general formula LiNiₓM₁₋ₓO₂ (where 0.7≦x<1, and M represents one or more metals) and the lithium-nickel composite Oxide B represented by the general formula LiNiₓCo_{y}M_{1-x-y}O₂ (where 0<x≦0.5, 0<y<1, and M represents one or more Metals excluding Co), lowering of the cyclability was able to be suppressed.

### REFERENCE SIGNS LIST

1 Negative electrode:
2 Positive electrode
3 Separator
4 Battery case
5 Sealing plate
6 Upper insulating plate
7 Lower insulating plate:
8 Positive electrode lead
9 Negative electrode lead
10 Positive electrode terminal
12 Negative electrode active material layer
14 Positive electrode active material layer
16 Unopposed region
30 Nonaqueous electrolyte secondary battery

1. A nonaqueous electrolyte secondary battery, comprising:
a negative electrode having a negative electrode active material layer;
a positive electrode having a positive electrode active material layer;
a separator interposed between the positive electrode and the negative electrode; and
a nonaqueous electrolyte,
wherein the battery is a negative electrode-restricted nonaqueous electrolyte secondary battery that stops charging as a result of an electric potential drop of the negative electrode,
wherein the negative electrode active material layer and the positive electrode active material layer have opposing surfaces, and the opposing surface of the negative electrode active material layer is larger than the opposing surface of the positive electrode active material layer, and
the positive electrode active material layer comprises:
a lithium-nickel composite oxide A represented by a general formula LiNiₓM₁₋ₓO₂ (where 0.7≦x<1, and M represents one or more metals); and
a lithium-nickel composite oxide B represented by a general formula LiNiₓCo_{y}M_{1-x-y}O₂ (where 0<x≦0.5, 0<y<1, and M represents one or more metals excluding Co).

2. The nonaqueous electrolyte secondary battery according to claim 1, wherein the negative electrode active material layer comprises lithium titanate.

3. The nonaqueous electrolyte secondary battery according to claim 2, wherein a mass ratio of the lithium-nickel composite oxide B to the lithium-nickel composite oxide A is in the range of 0.1 or more and less than 0.5.

4. The nonaqueous electrolyte secondary battery according to claim 1, wherein the opposing surface of the positive electrode active material is arranged relative to the opposing surface of the negative electrode active material such that the opposing surface of the negative electrode active material has an unopposed region around the entire opposing surface of the positive electrode active material.
